(19) United States
(12) Patent Application Publication
(10) Pub. No.: US 2026/0178283 A1
(43) Pub. Date: Jun. 25, 2026

(54) COLLABORATIVE LANGUAGE MODELS IN NOTEBOOK ENVIRONMENTS

(71) Applicant: Microsoft Technology Licensing, LLC, Redmond, WA (US)

(72) Inventors: Peng LYU, Sammamish, WA (US); Kai-Uwe MAETZEL, Seattle, WA (US)

(21) Appl. No.: 18/999,734

(22) Filed: Dec. 23, 2024

(51) Int. Cl. G06F 8/30; G06F 40/166

(52) U.S. Cl. CPC G06F 8/30; G06F 40/166

(57) ABSTRACT

Language models may be used for software code generation, and generation of other images and text, in notebook documents, expanding collaboration opportunities with reviewers. Further, multiple different language models may be used in various segments of the notebook, enabling collaboration among the language models. In addition to the descriptive text (markdown), software code, and rich outputs, a new prompt layer is introduced that retains, in the distributed notebook file, prompts used by language models for software code generation and/or other tasks. Thus, a reviewer does not need programming expertise to alter the software code in the notebook in order to change an output. Different language models may be used within a single notebook to leverage relative strengths (i.e., one language model for code generation and another for image generation or classification). In some examples, output from one language model may be used in a prompt for another language model.

### BACKGROUND

Recently-available notebooks are sharable JavaScript Object Notation (JSON) documents that combine plain language descriptive text, software source code, and outputs from the executed software source code, such as charts, graphs and figures. A notebook provides a fast interactive environment for prototyping and explaining code, exploring and visualizing data, and sharing ideas. Each segment of the notebook document stored in a cell, and the notebooks are typically saved as *.ipynb files (a type of JSON file, with strict formatting requirements).

Although notebooks are a convenient way for an author to share work that includes software source code data and rich visualization outputs, if a reviewer wishes to change any of the software source code, in order to alter any of the outputs, the reviewer needs programming expertise in the language of the software source code used in the notebook. This limits collaboration opportunities with reviewers.

### SUMMARY

The disclosed examples are described in detail below with reference to the accompanying drawing figures listed below. The following summary is provided to illustrate some examples disclosed herein.

Solutions disclosed herein provide for collaborative language models in notebook environments. Language models may be used for software source code generation, and generation of other images and text, expanding collaboration opportunities with reviewers. Further, multiple different language models may be used in various segments of the notebook, enabling collaboration among the different language models.

Examples generate a notebook in a first notebook execution environment, wherein the notebook comprises markdown and a first prompt cell comprising a first prompt; generate, in the first notebook execution environment, a first code cell using the first prompt in the first prompt cell, wherein generating the first code cell comprises passing the first prompt to a first language model, and wherein the first code cell comprises first software code; generate, in the first notebook execution environment, a first output using the first software code in the first code cell, wherein generating the first output comprises executing the first software code; and save a notebook file as a JavaScript Object Notation (JSON) file comprising the notebook and metadata for the notebook.

Additional examples open a notebook file in a notebook execution environment, wherein the notebook file comprises a notebook and a metadata for the notebook, and wherein the notebook comprises markdown, a first prompt cell, a first code cell, and a first output; edit a first prompt in the first prompt cell; generate, in the notebook execution environment, an updated first code cell using the edited first prompt, wherein generating the updated first code cell comprises passing the edited first prompt to a language model, and wherein the updated first code cell comprises updated first software code; and generate, in the notebook execution environment, an updated first output using the updated first software code in the updated first code cell, wherein generating the updated first output comprises executing the updated first software code.

Additional examples generate a notebook in a first notebook execution environment, wherein the notebook comprises markdown and a first prompt cell comprising a first prompt; generate, in the first notebook execution environment, a second prompt in a second prompt cell using the first prompt in the first prompt cell, wherein generating the second prompt comprises passing the first prompt to a first language model; generate, in the first notebook execution environment, an output using the second prompt, wherein generating the output comprises passing the second prompt to a second language model; and save a notebook file as a JSON file comprising the notebook and metadata for the notebook.

### BRIEF DESCRIPTION OF THE DRAWINGS

The disclosed examples are described in detail below with reference to the accompanying drawing figures listed below:

FIG. 1 illustrates an example architecture that advantageously provides for collaborative language models in notebook environments;

FIGS. 2A and 2B illustrate an exemplary notebook file, as may be used by examples of the architecture of FIG. 1;

FIG. 2C illustrates example generated software code (source code), such as may be generated for the exemplary notebook file FIGS. 2A and 2B;

FIG. 3 illustrates an exemplary updated notebook file, updated from the exemplary notebook file of FIGS. 2A and 2B, as may be generated by examples of the architecture of FIG. 1;

FIGS. 4A and 4B together illustrate an example of an actual notebook, as may be used by examples of the architecture of FIG. 1;

FIGS. 5A and 5B together show a flowchart illustrating exemplary operations that may be performed when using example architectures, such as the architecture of FIG. 1;

FIGS. 6A, 6B, and 6C show additional flowcharts illustrating exemplary operations that may be performed when using example architectures, such as the architecture of FIG. 1; and

FIG. 7 shows a block diagram of an example computing device suitable for implementing some of the various examples disclosed herein.

Corresponding reference characters indicate corresponding parts throughout the drawings.

### DETAILED DESCRIPTION

Language models may be used for software code generation, and generation of other images and text, in notebook documents, expanding collaboration opportunities with reviewers. Further, multiple different language models may be used in various segments of the notebook, enabling collaboration among the language models. In addition to the descriptive text (markdown), software code, and rich outputs, a new prompt layer is introduced that retains, in the distributed notebook file, prompts used by language models for software code generation and/or other tasks. Thus, a reviewer does not need programming expertise to alter the software code in the notebook in order to change an output. Different language models may be used within a single notebook to leverage relative strengths (i.e., one language model for code generation and another for image generation or classification). In some examples, output from one language model may be used in a prompt for another language model.

Aspects of the disclosure solve multiple problems that are necessarily rooted in computer technology, and render computing platforms more effective and responsive to user needs, by providing the practical result of enabling reviewers to alter software code without needing programming expertise. Additionally, examples permit notebook documents to foster collaboration among language models. This significantly improves the utility of notebook documents. These advantageous results are accomplished, at least in part, by generating, in a notebook execution environment, a code cell using a prompt in a prompt cell, wherein generating code cell comprises passing the prompt to a first language model, and wherein the code cell comprises software code. In some examples, a first output (from the first language model) comprises a second prompt cell (for a second language model).

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

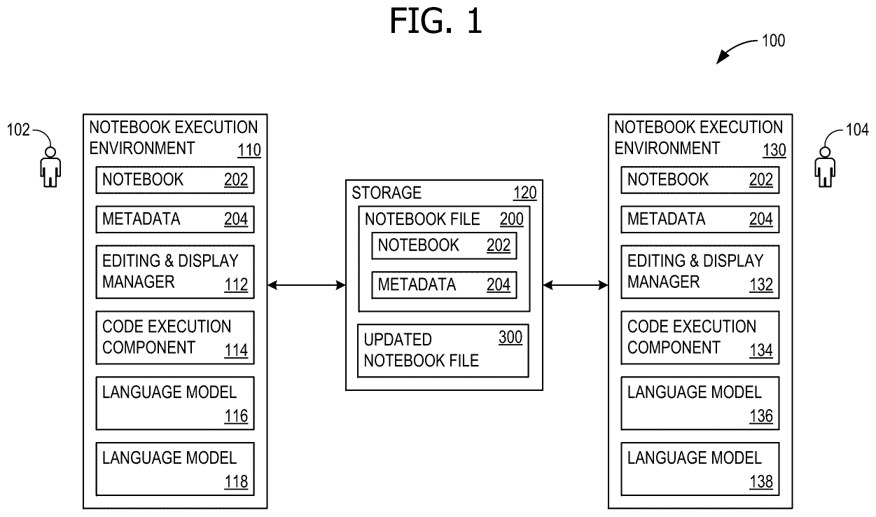

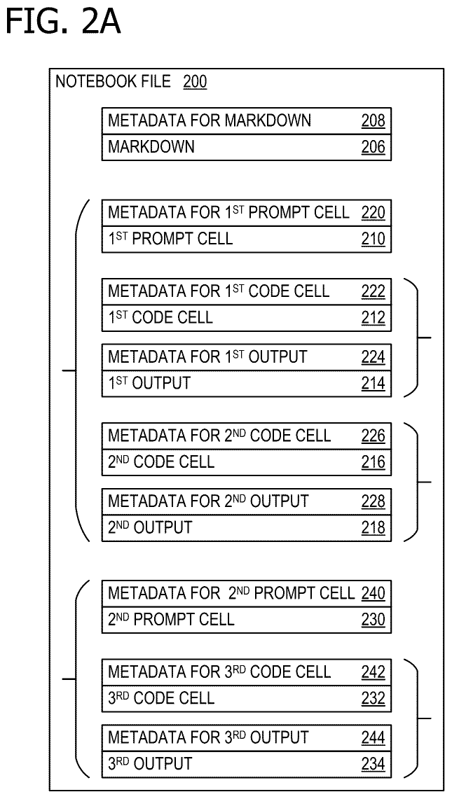

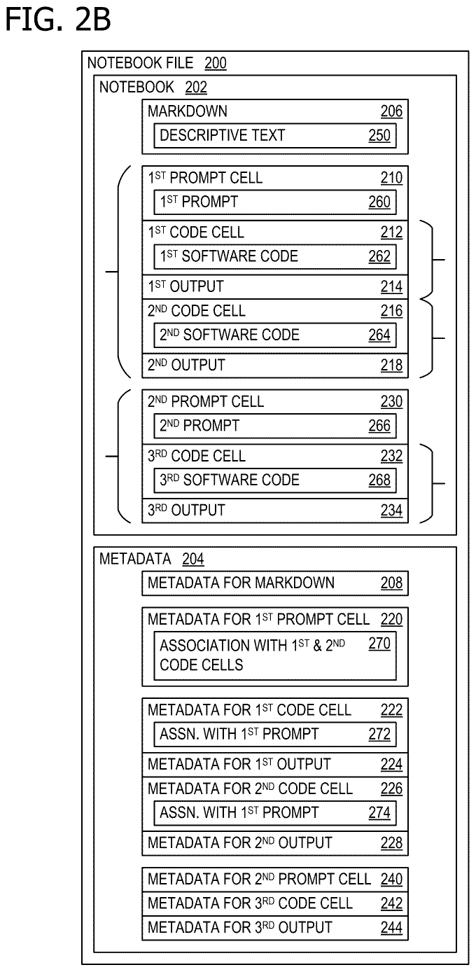

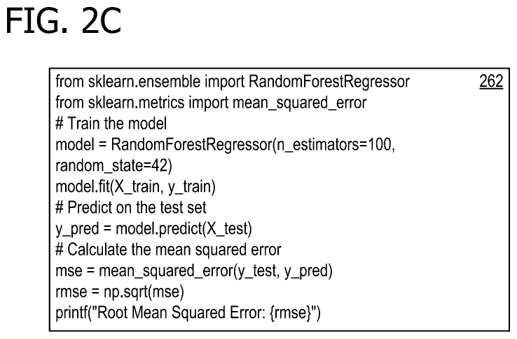

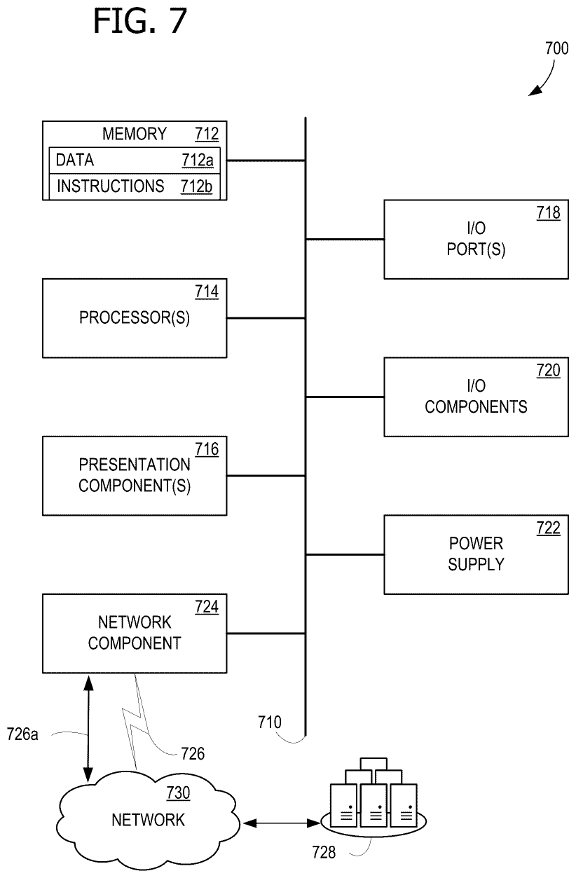

FIG. 1 illustrates an example architecture 100 that advantageously provides for collaborative language models in notebook environments. An author 102 creates (generates) a notebook 202 in a notebook execution environment 110, which may be local or at least partially located across a computer network (e.g., a private network or the internet), and/or is virtualized or distributed among multiple hardware computing devices (such as is shown in FIG. 7). Notebook 202 has associated metadata 204, and author 102 edits notebook 202 within a notebook editing and display manager 112. Notebook 202 and metadata 204 are shown in further detail in FIGS. 2A and 2B.

Common example notebooks include a house price analysis, a customer segmentation notebook, and multiple image classification notebooks, which are available on GitHub. The house price analysis notebook is widely available as House_Price_Anaysis.ipynb, which analyzes a dataset of house prices and includes data cleaning, exploration, modeling, and evaluation using linear and ridge regression. The customer segmentation notebook is widely available as Customer_Segmentation.ipynb and is useful in marketing projects by identifying several segments of customers that share a similarity relevant to marketing such as gender, age, interests, and miscellaneous spending habits. An image classification notebooks is widely available as Image_Classification.ipynb and shows how to fine-tune various pretrained computer vision (CV) models for image classification on a custom dataset. Notebook 202 may be a derivative of one of these examples, or some other project.

A code execution component 114 in, or accessible to, notebook execution environment 110 executes software code in notebook 202, which may be python, visual studio (VS) code, structured query language (SQL), or another software code. Notebook execution environment 110 also either has, or has access to, a language model 116 and a language model 118. Language model 116 and language model 118 may each comprises a large language model (LLM), or more generically, a multimodal model (MM), and be any of a generative pre-trained transformer (GPT), Copilot, Gemini, Claude, and Llama.

Generally, a language model is a probabilistic model of a natural language. LLMs are combinations of larger datasets (frequently using words in some language, whether a human language or a programming language), feedforward neural networks, and transformers designed for language processing tasks such as language generation. As language models, LLMs acquire these abilities by learning statistical relationships from vast amounts of example training material (e.g., text for human language and software code for programming languages) during self-supervised and/or semi-supervised training processes using transformer architecture.

The most capable LLMs tend to use artificial neural networks (NNs) built with a decoder-only transformer-based architecture, enabling efficient processing and generation of large-scale language passages. Models may be fine-tuned for specific tasks, or be guided by prompt engineering, and may acquire predictive power regarding syntax, semantics, and ontologies inherent in language corpora.

In general, language model 116 and language model 118 are different language models, with different relative strengths (e.g., different fine-tuning for differently-focused tasks) and thus differ in performance (i.e., speed and/or accuracy). Different language models excel in various tasks due to their architecture, training data, and optimization strategies. For example, language model 116 may generate code snippets faster and with higher accuracy, while language model 118 produces superior results in image generation and classification. That is, one language model may be associated with superior code generation performance, whereas the other may be associated with superior performance for image generation, image classification, image interpretation, and/or text generation or interpretation. These differences highlight the need to choose the right model for specific use cases.

Notebook execution environment 110 has access to multiple different language models in order to enable author 102 to select a first language model for use within notebook 202 based on that first language model's area of excellence, and also to select a second language model for use elsewhere within notebook 202 based on that second language model's area of excellence. For example, language model 116 and language model 136 may be associated with superior code generation performance, whereas language model 118 and language model 138 are associated with superior image generation and image classification performance. The identification of which language model to use in each segment of notebook 202 is indicated either within language model prompts within notebook 202 (see FIGS. 2A and 2B) and/or within metadata 204.

Author 102 saves notebook 202 and metadata 204 within a notebook file 200, which may be a JavaScript Object Notation (JSON) file, in a storage 120. In some examples, notebook file 200 is saved as an *.ipynb file, which is a type of JSON file, with strict formatting requirements. By providing at least a reviewer 104 with access to notebook file 200 in storage 120 (possibly along with other reviewers), notebook file 200 is distributed. In some examples, author 102 may email notebook file 200 to one or more recipients, such as reviewer 104, to distribute it.

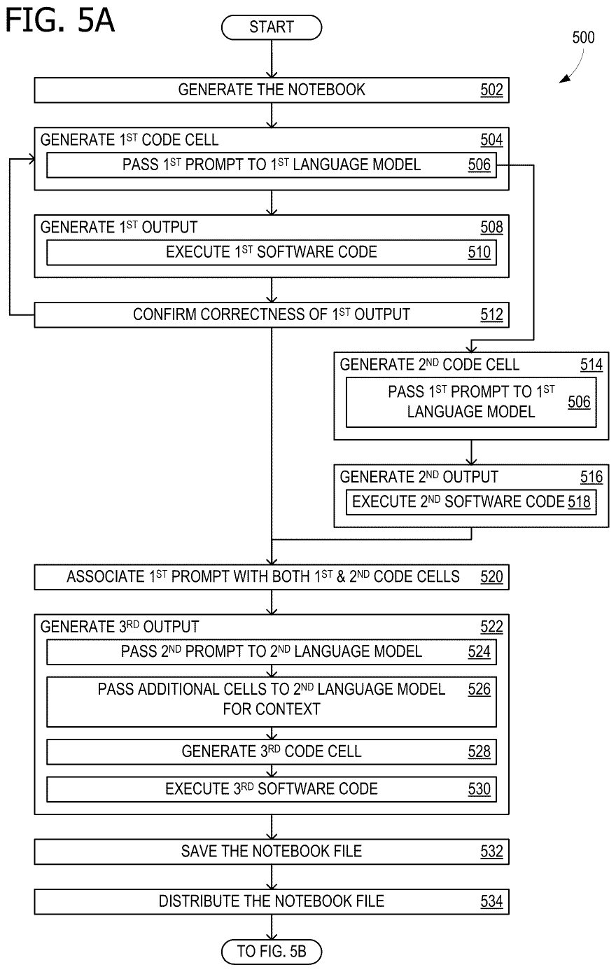

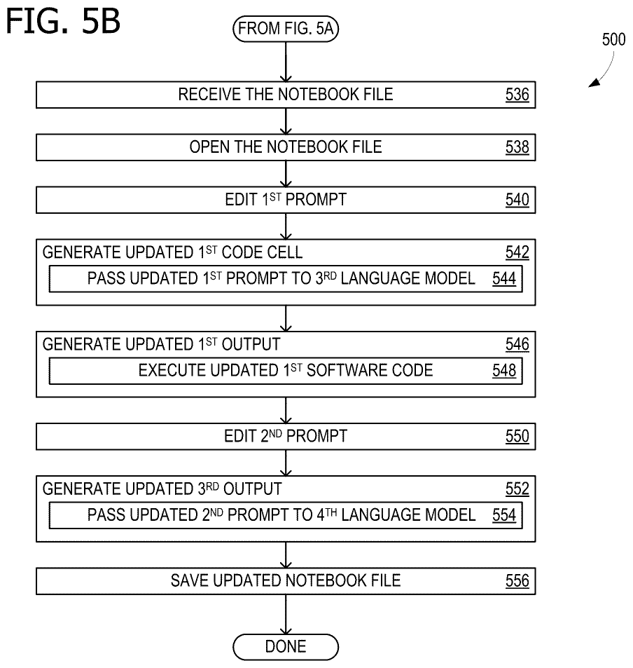

Reviewer 104 opens notebook file 200 in a notebook execution environment 130, which may be functionally equivalent to notebook execution environment 110. That is, notebook execution environment 130 has a notebook editing and display manager 132 for editing notebook 202, a code execution component 134 for executing software code in notebook 202, and access to a language model 136 and a language model 138. Notebook editing and display manager 132, code execution component 134, language model 136, and language model 138 are at least roughly functionally equivalent to their counterparts in notebook execution environment 110. For example, language model 136 may be equivalent to, or the same as, language model 116, and language model 138 may be equivalent to, or the same as, language model 118. As described in further detail in relation to FIGS. 5A and 5B, reviewer 104 edits notebook 202 and saves an updated notebook file 300 in storage 120.

FIGS. 2A and 2B illustrate further detail for notebook file 200. FIG. 2A shows contents of notebook 202 and metadata 204 as they may be written in order, within notebook file 200, whereas FIG. 2B shows contents of notebook file 200 logically separated into notebook 202 and metadata 204. Notebook editing and display manager 112 and notebook editing and display manager 132 will typically display contents of notebook 202 to author 102 and reviewer 104 while hiding contents of metadata 204, which may be automatically generated. However, some examples of notebook editing and display manager 112 and notebook editing and display manager 132 may also permit revealing (and manually editing) contents of metadata 204, if the proper option is selected in the user interface (UI).

Turning first to FIG. 2A, notebook file 200 has markdown 206 (e.g., descriptive text) and associated metadata 208 for markdown 206; a prompt cell 210, identified as a first prompt cell, and associated metadata 220 for prompt cell 210; a code cell 212, identified as a first code cell, and associated metadata 222 for code cell 212; an output 214, identified as a first output, and associated metadata 224 for output 214; a code cell 216, identified as a second code cell, and associated metadata 226 for code cell 216; another output 218, identified as a second output, and associated metadata 228 for output 218; another prompt cell 230, identified as a second prompt cell, and associated metadata 240 for prompt cell 230; another code cell 232, identified as a third code cell, and associated metadata 242 for code cell 232; and another output 234, identified as a third output, and associated metadata 244 for output 234. Some notebook files may have a different number of segments (e.g., cells), and/or markdown distributed among the different prompt cells and code cells.

Turning now to FIG. 2B, notebook 202 (which has the content that is displayed by default to the user, author 102 or reviewer 104) has markdown 206 comprising descriptive text 250; prompt cell 210 comprising a prompt 260, identified as a first prompt; code cell 212 comprising software code 262, identified as a first software code; output 214; code cell 216 comprising software code 264, identified as a second software code; output 218; prompt cell 230 comprising a prompt 266, identified as a second prompt; code cell 232 comprising software code 268, identified as a third software code; and output 234. Metadata 204 for notebook 202 has metadata 208 for markdown 206, metadata 220 for prompt cell 210, metadata 222 for code cell 212, metadata 224 for output 214; metadata 226 for code cell 216, metadata 228 for output 218, metadata 240 for prompt cell 230, metadata 242 for code cell 232, and metadata 244 for output 234.

An example of generated source code, such as software code 262, is shown in FIG. 2C, which uses a random forest regression, a statistical algorithm that is used to cluster points of data in functional groups.

In an illustrated example, prompt cell 210 is used to generate both software code 262 in code cell 212 and software code 264 in code cell 216. This information needs to be tracked somewhere. In some examples, this is placed in metadata 220 for prompt cell 210, which is shown as an association 270 (of prompt cell 210 with code cell 212 and code cell 216), or placed into the metadata for each of code cell 212 and code cell 216. For example, metadata 222 for code cell 212 has an association 272 (of code cell 212 with prompt cell 210), and metadata 226 for code cell 216 has an association 274 (of code cell 216 with prompt cell 210). Each of association 270, association 272, and association 274 may be a tag or label within metadata 204 (e.g., metadata 206) identifying the various cells being associated and the nature of the association.

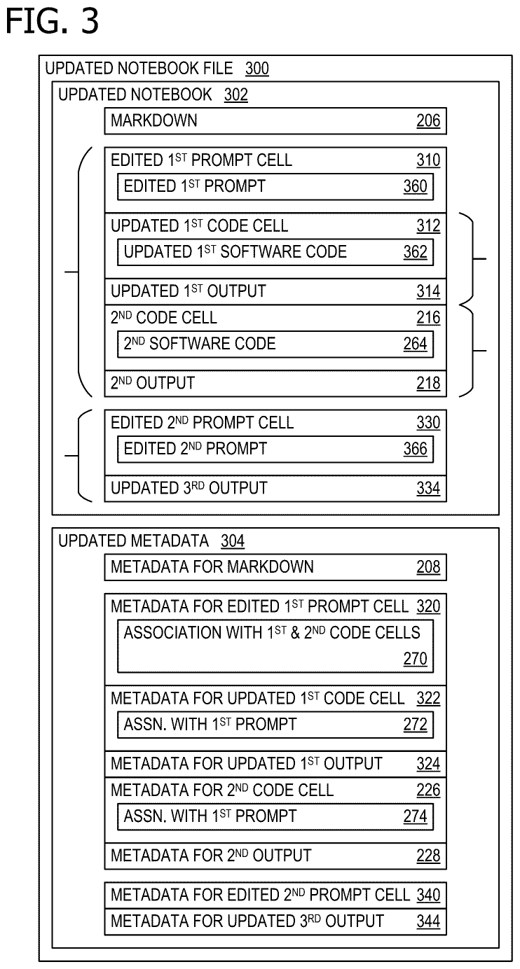

FIG. 3 illustrates an exemplary updated notebook file 300, updated from notebook file 200, and after reviewer 104 edits notebook 202, as described in relation to FIGS. 5A and 5B. Updated notebook file 300 is similar to notebook file 200, although with some differences noted below.

Notebook 202 and metadata 204 are replaced by an updated notebook 302 and updated metadata 304 for updated notebook 302. An edited prompt cell 310 with an edited prompt 360 replaces prompt cell 210 with prompt 260. An updated code cell 312 with updated software code 362 replaces code cell 212 with updated software code 262. An updated output 314 replaces output 214. An edited prompt cell 330 with an edited prompt 366 replaces prompt cell 230 with prompt 266. An updated output 334 replaces output 234. Metadata 320 for edited prompt cell 310 replaces metadata 220. Metadata 322 for updated code cell 312 replaces metadata 222. Metadata 324 for updated output 314 replaces metadata 224. Metadata 340 for edited prompt cell 330 replaces metadata 240. Metadata 344 for updated output 334 replaces metadata 244.

Additionally, code cell 232 and metadata 242 are absent, indicating that prompt cells do not necessarily have prompts that generate software code, but may also have prompts that employ language models to generate other forms of rich output, such as output text, an image, audio data, and other output types. In some examples, the output text comprises a natural language (NL) passage (e.g., a narration or descriptive text), a data table, or html. In some examples, the output text comprises prompt for another language model.

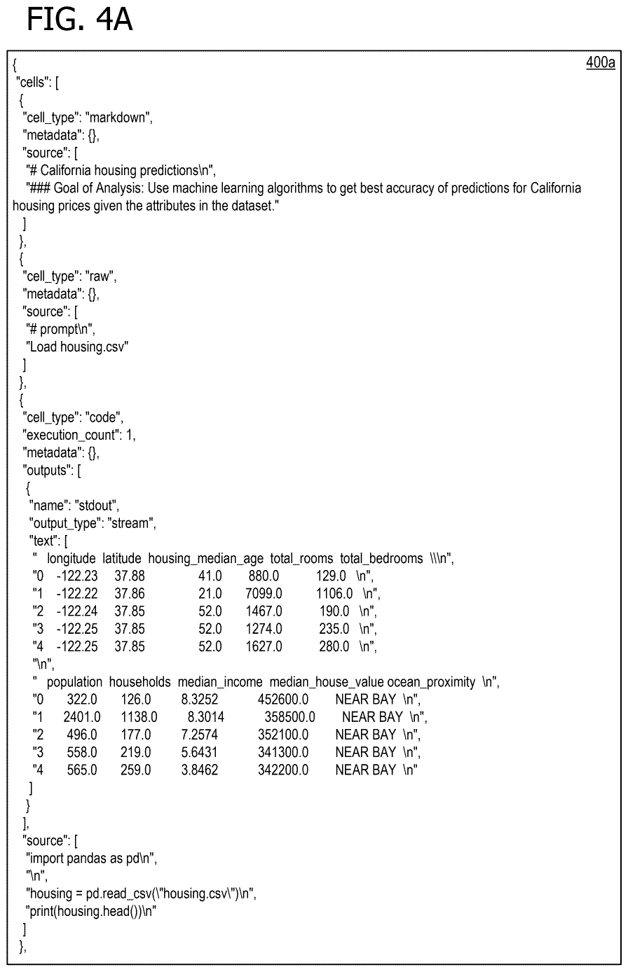

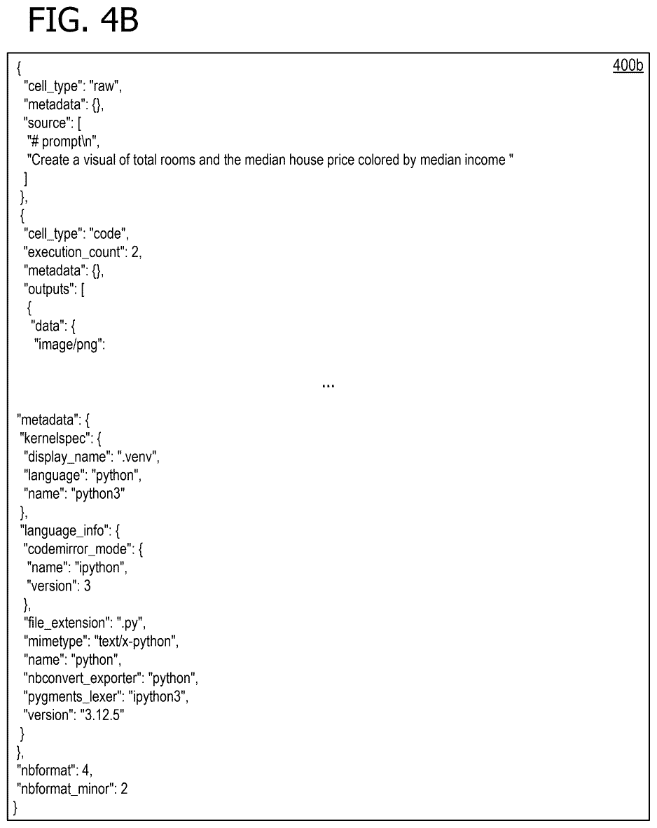

FIGS. 4A and 4B illustrates an example of an actual notebook document, such as an example for notebook 202. FIG. 4A has a first portion 400a of a notebook document in the *.ipynb format, followed by a second portion 400b of the notebook document. For brevity, to enable display in the figures, second portion 400b is truncated, removing the figure data that is preceded by ““data”: {“image/png”: ” and then resuming with the final closing lines, starting with ““metadata”: {“kernelspec”: {”.

FIGS. 5A and 5B together show a flowchart 500 illustrating exemplary operations that may be performed by architecture 100. Flowchart 500 spans FIGS. 5A and 5B, and in some examples, operations described for flowchart 500 are performed by computing device 700 of FIG. 7. Flowchart 500 commences with author 102 generating (creating and editing) notebook 202 in notebook execution environment 110 in operation 502, as shown in FIG. 5A. Early in this process, notebook 202 comprises markdown 206 and prompt cell 210 comprising prompt 260, as well as possibly prompt cell 230 comprising prompt 266. Markdown 206 comprises descriptive text 250, and notebook execution environment 110 is communicatively coupled to both language model 116 and language model 118, as well as code execution component 114.

In operation 504, notebook execution environment 110 generates code cell 212 using prompt 260 in prompt cell 210. In some example, code cell 212 is generated by passing at least prompt 260 to GitHub CoPilot, which uses GPT running on Azure. Other code-generation LLMs may also be used. Code generation may be optimized by optimizing prompt 260 based on the context information around prompt cell 210, such as by including markdown and other prompts cells preceding prompt 260 (e.g., one or two immediately preceding prompt cells or immediately following prompt cells and intervening markdown). In general, a language model is able to leverage additional context by processing a follow-up prompt or markdown input. This allows it to refine its understanding of the task, generate more relevant outputs, and maintain coherence across multi-step workflows, improving its adaptability for complex applications.

Code cell 212 then has software code 262 which may be any of python, VS code, and SQL. Software code 264 and software code 268, used later in flowchart 500, may be any of the same types of executable code. Operation 504 is performed using operation 506 that passes prompt 260 to language model 116. In this described example, language model 116 is used for code generation. Any of language model 116 and the language models used later in flowchart 500 (language model 118, language model 136, and language model 136) may include an LLM or MM, and may be any of a GPT, Copilot, Gemini, Claude, Llama, or another.

Notebook execution environment 110 generates output 214 by executing (i.e., using) software code 262 in code cell 212, in operation 508. See the example of software code 262 in FIG. 2C. This is performed by code execution component 114 executing software code 262 in operation 510. In some examples, operation 512 passes output 214 back to language model 116 to assess whether output 214 is correct. If not, software code 262 is generated again in operation 506 (with a corrected version of prompt 260.

In some examples, prompt cell 210 is able to generate two code cells, and operation 506 is also used to generate software code 264 in code cell 216 using prompt 260 in prompt cell 210, in operation 514. Operation 516 then generates output 218 using software code 264 in code cell 216, in notebook execution environment 110. This is performed by code execution component 114 executing software code 264 in operation 518.

For Output 214 and output 218 (along with other outputs generated later in flowchart 500, such as output 234, updated output 314, and updated output 334) may be any of output text, an image, audio data, a software widget, or another rich output. In some examples, output text may be an NL passage, data table, html, or even a prompt for another language model.

In some examples, an output text, such as output 218 (or another output) may be generated directly from one language model rather than using software code in a code cell. This is illustrated in FIG. 3 for updated output 334. When an output from one language model includes a prompt for another language model, this enables collaboration between different language models using a notebook.

In this alternative operation for flowchart 500, operation 514 instead uses prompt cell 210 to generate a language model prompt in place of software code 264, such that code cell 216 is instead a prompt cell, and software code 264 is instead a prompt. Operation 516 then generates output 218 by passing the prompt to language model 118 in operation 518 (rather than executing software code 264).

Returning to the primary operation of flowchart 500, operation 520 identifies that prompt cell 210 is associated with generation of code cell 212 and code cell 216, in notebook file 200 (e.g., in metadata 204). This may be accomplished using a tag or label within metadata 204. Notebook execution environment 110 then generates output 234 using prompt 266 in prompt cell 230, in operation 522. This may be accomplished by passing prompt 266 to language model 118 in operation 524.

In some examples, additional information is passed to a language model, beyond just the immediate prompt cell, in order to provide context for the language model. This can improve the performance of the language model. For example, operation 526 passes another prompt or markdown to language model 118 for context, in addition to prompt 266. When language model 118 is being used for code completion, operation 528 generates code cell 232 using prompt 266 in prompt cell 230. Code cell 232 holds software code 268, which is executed in operation 530.

Author 102 saves notebook file 200 to storage 120 in operation 532 and distributes notebook file 200 in operation 534. Notebook file 200 comprises notebook 202 and metadata 204 and, in some examples, notebook file 200 is a JSON file, such as an *.ipynb file. In some examples, prompt cell 210 is associated with generation of code cell 212 and code cell 216 in metadata 204 for notebook 202. This may be, for example, a label or tag within metadata 204 that prompt cell 210 generates the contents of code cell 212 and code cell 216. In some examples, this is accomplished by prompt cell 210 being associated with generation of code cell 212 and code cell 216 in metadata 220 for prompt cell 210. In some examples, this is accomplished by prompt cell 210 being associated with generation of code cell 212 in metadata 222 for code cell 212 and also by prompt cell 210 being associated with generation of code cell 216 in metadata 226 for code cell 216.

Turning to FIG. 5B, reviewer 104 receives notebook file 200 in operation 536, such as by retrieving notebook file 200 from storage 120 or in an email or other media. Reviewer 104 opens notebook file 200 in notebook execution environment 130 in operation 538. At this point, notebook 202 comprises at least markdown 206, prompt cell 210, code cell 212, and output 214. Notebook execution environment 130 may be functionally equivalent to notebook execution environment 110, for example by being is communicatively coupled to both language model 136 and language model 138. In some examples, however, there may be some differences in supported languages and available language models between notebook execution environment 130 and notebook execution environment 110.

Reviewer 104 edits prompt 260 in prompt cell 210 in operation 540, and in operation 542, notebook execution environment 130 generates updated code cell 312 using edited prompt 360. Updated code cell 312 comprises updated software code 362. This is performed by passing edited prompt 360 to language model 136 in operation 544. Operation 546 generates updated output 314 using updated software code 362 in updated code cell 312. This is performed by code execution component 134 executing updated software code 362 in operation 548.

Reviewer 104 edits prompt 266 in prompt cell 230 in operation 550, and in operation 552, notebook execution environment 130 generates updated output 334 using edited prompt 366 in edited prompt cell 330. This is accomplished by passing edited prompt 366 to language model 138 in operation 554. Reviewer 104 saves updated notebook file 300, comprising updated notebook 302 and updated metadata 304 for updated notebook 302, in operation 556. Updated notebook file 300 may be saved as a JSON file, such as a *.ipynb file. In some examples, reviewer 104 is author 102 and notebook execution environment 130 is notebook execution environment 110.

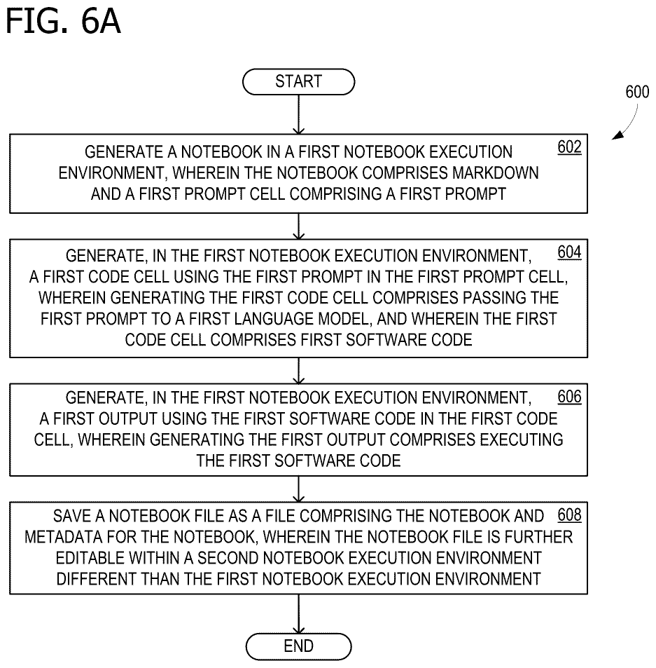

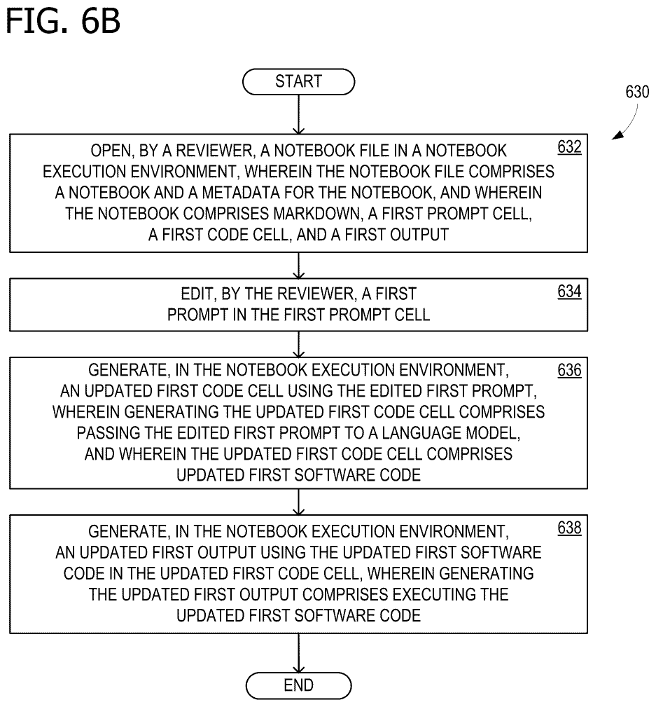

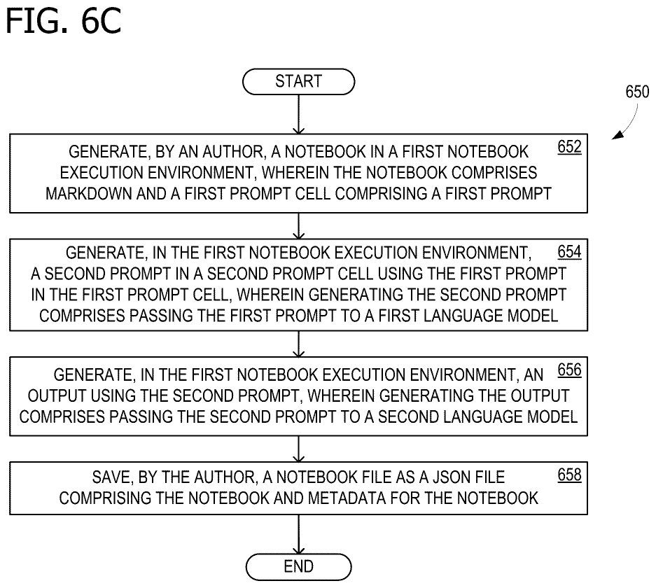

FIG. 6A shows a flowchart 600 illustrating exemplary operations that may be performed by architecture 100. In some examples, operations described for flowchart 600 are performed by computing device 700 of FIG. 7. Flowchart 600 commences with operation 602, which includes generating a notebook in a first notebook execution environment, wherein the notebook comprises markdown and a first prompt cell comprising a first prompt.

Operation 604 includes generating, in the first notebook execution environment, a first code cell using the first prompt in the first prompt cell, wherein generating the first code cell comprises passing the first prompt to a first language model, and wherein the first code cell comprises first software code. Operation 606 includes generating, in the first notebook execution environment, a first output using the first software code in the first code cell, wherein generating the first output comprises executing the first software code. Operation 608 includes saving a notebook file as a file comprising the notebook and metadata for the notebook, wherein the notebook file is further editable within a second notebook execution environment different than the first notebook execution environment.

FIG. 6B shows a flowchart 630 illustrating exemplary operations that may be performed by architecture 100. In some examples, operations described for flowchart 630 are performed by computing device 700 of FIG. 7. Flowchart 630 commences with operation 632, which includes opening a notebook file in a notebook execution environment, wherein the notebook file comprises a notebook and a metadata for the notebook, and wherein the notebook comprises markdown, a first prompt cell, a first code cell, and a first output.

Operation 634 includes editing a first prompt in the first prompt cell. Operation 636 includes generating, in the notebook execution environment, an updated first code cell using the edited first prompt, wherein generating the updated first code cell comprises passing the edited first prompt to a language model, and wherein the updated first code cell comprises updated first software code. Operation 638 includes generating, in the notebook execution environment, an updated first output using the updated first software code in the updated first code cell, wherein generating the updated first output comprises executing the updated first software code.

FIG. 6C shows a flowchart 650 illustrating exemplary operations that may be performed by architecture 100. In some examples, operations described for flowchart 650 are performed by computing device 700 of FIG. 7. Flowchart 650 commences with operation 652, which includes generating a notebook in a first notebook execution environment, wherein the notebook comprises markdown and a first prompt cell comprising a first prompt.

Operation 654 includes generating, in the first notebook execution environment, a second prompt in a second prompt cell using the first prompt in the first prompt cell, wherein generating the second prompt comprises passing the first prompt to a first language model. Operation 656 includes generating, in the first notebook execution environment, an output using the second prompt, wherein generating the output comprises passing the second prompt to a second language model. Operation 658 includes saving a notebook file as a JSON file comprising the notebook and metadata for the notebook.

### Additional Examples

An example system comprises: a processor; and a computer-readable medium storing instructions that are operative upon execution by the processor to: generate a notebook in a first notebook execution environment, wherein the notebook comprises markdown and a first prompt cell comprising a first prompt; generate, in the first notebook execution environment, a first code cell using the first prompt in the first prompt cell, wherein generating the first code cell comprises passing the first prompt to a first language model, and wherein the first code cell comprises first software code; generate, in the first notebook execution environment, a first output using the first software code in the first code cell, wherein generating the first output comprises executing the first software code; and save a notebook file as a file comprising the notebook and metadata for the notebook, wherein the notebook file is further editable within a second notebook execution environment different than the first notebook execution environment.

Another example system comprises: a processor; and a computer-readable medium storing instructions that are operative upon execution by the processor to: open a notebook file in a notebook execution environment, wherein the notebook file comprises a notebook and a metadata for the notebook, and wherein the notebook comprises markdown, a first prompt cell, a first code cell, and a first output; edit a first prompt in the first prompt cell; generate, in the notebook execution environment, an updated first code cell using the edited first prompt, wherein generating the updated first code cell comprises passing the edited first prompt to a language model, and wherein the updated first code cell comprises updated first software code; and generate, in the notebook execution environment, an updated first output using the updated first software code in the updated first code cell, wherein generating the updated first output comprises executing the updated first software code.

Another example system comprises: a processor; and a computer-readable medium storing instructions that are operative upon execution by the processor to: generate a notebook in a first notebook execution environment, wherein the notebook comprises markdown and a first prompt cell comprising a first prompt; generate, in the first notebook execution environment, a second prompt in a second prompt cell using the first prompt in the first prompt cell, wherein generating the second prompt comprises passing the first prompt to a first language model; generate, in the first notebook execution environment, an output using the second prompt, wherein generating the output comprises passing the second prompt to a second language model; and save a notebook file as a JSON file comprising the notebook and metadata for the notebook.

An example computer-implemented method comprises: generating a notebook in a first notebook execution environment, wherein the notebook comprises markdown and a first prompt cell comprising a first prompt; generating, in the first notebook execution environment, a first code cell using the first prompt in the first prompt cell, wherein generating the first code cell comprises passing the first prompt to a first language model, and wherein the first code cell comprises first software code; generating, in the first notebook execution environment, a first output using the first software code in the first code cell, wherein generating the first output comprises executing the first software code; and saving a notebook file as a file comprising the notebook and metadata for the notebook, wherein the notebook file is further editable within a second notebook execution environment different than the first notebook execution environment.

Another example computer-implemented method comprises: opening a notebook file in a notebook execution environment, wherein the notebook file comprises a notebook and a metadata for the notebook, and wherein the notebook comprises markdown, a first prompt cell, a first code cell, and a first output; editing a first prompt in the first prompt cell; generating, in the notebook execution environment, an updated first code cell using the edited first prompt, wherein generating the updated first code cell comprises passing the edited first prompt to a language model, and wherein the updated first code cell comprises updated first software code; and generating, in the notebook execution environment, an updated first output using the updated first software code in the updated first code cell, wherein generating the updated first output comprises executing the updated first software code.

Another example computer-implemented method comprises: generating a notebook in a first notebook execution environment, wherein the notebook comprises markdown and a first prompt cell comprising a first prompt; generating, in the first notebook execution environment, a second prompt in a second prompt cell using the first prompt in the first prompt cell, wherein generating the second prompt comprises passing the first prompt to a first language model; generating, in the first notebook execution environment, an output using the second prompt, wherein generating the output comprises passing the second prompt to a second language model; and saving a notebook file as a JSON file comprising the notebook and metadata for the notebook.

One or more example computer storage devices have computer-executable instructions stored thereon, which, on execution by a computer, cause the computer to perform operations comprising: generating a notebook in a first notebook execution environment, wherein the notebook comprises markdown and a first prompt cell comprising a first prompt; generating, in the first notebook execution environment, a first code cell using the first prompt in the first prompt cell, wherein generating the first code cell comprises passing the first prompt to a first language model, and wherein the first code cell comprises first software code; generating, in the first notebook execution environment, a first output using the first software code in the first code cell, wherein generating the first output comprises executing the first software code; and saving a notebook file as a file comprising the notebook and metadata for the notebook, wherein the notebook file is further editable within a second notebook execution environment different than the first notebook execution environment.

One or more additional example computer storage devices have computer-executable instructions stored thereon, which, on execution by a computer, cause the computer to perform operations comprising: opening a notebook file in a notebook execution environment, wherein the notebook file comprises a notebook and a metadata for the notebook, and wherein the notebook comprises markdown, a first prompt cell, a first code cell, and a first output; editing a first prompt in the first prompt cell; generating, in the notebook execution environment, an updated first code cell using the edited first prompt, wherein generating the updated first code cell comprises passing the edited first prompt to a language model, and wherein the updated first code cell comprises updated first software code; and generating, in the notebook execution environment, an updated first output using the updated first software code in the updated first code cell, wherein generating the updated first output comprises executing the updated first software code.

One or more additional example computer storage devices have computer-executable instructions stored thereon, which, on execution by a computer, cause the computer to perform operations comprising: Another example computer-implemented method comprises: generating a notebook in a first notebook execution environment, wherein the notebook comprises markdown and a first prompt cell comprising a first prompt; generating, in the first notebook execution environment, a second prompt in a second prompt cell using the first prompt in the first prompt cell, wherein generating the second prompt comprises passing the first prompt to a first language model; generating, in the first notebook execution environment, an output using the second prompt, wherein generating the output comprises passing the second prompt to a second language model; and saving a notebook file as a JSON file comprising the notebook and metadata for the notebook.

Alternatively, or in addition to the other examples described herein, examples include any combination of the following:
generating, in the first notebook execution environment, a second code cell using the first prompt in the first prompt cell;
generating the second code cell comprises passing the first prompt to the first language model;
the second code cell comprises second software code;
generating, in the first notebook execution environment, a second output using the second software code in the second code cell;
generating the second output comprises executing the second software code;
identifying, in the notebook file, that the first prompt cell is associated with generation of the first code cell and the second code cell using a tag or label within metadata;
the notebook further comprises a second prompt cell comprising a second prompt;
generating, in the first notebook execution environment, a third output using the second prompt in the second prompt cell;
generating the third output comprises passing the second prompt to a second language model different than the first language model;
the first language model and the second language model differ in performance (speed and/or accuracy) for each code generation, image generation, and image classification;
generating the third output further comprises, in addition to passing the second prompt to the second language model, also passing another prompt or markdown to the second language model for context;
opening the notebook file in a second notebook execution environment;
the notebook file comprises the notebook and the metadata for the notebook;
the notebook comprises the markdown, the first prompt cell, the first code cell, and the first output;
editing the first prompt in the first prompt cell;
generating, in the second notebook execution environment, an updated first code cell using the edited first prompt;
generating the updated first code cell comprises passing the edited first prompt to a third language model;
the updated first code cell comprises updated first software code;
generating, in the second notebook execution environment, an updated first output using the updated first software code in the updated first code cell;
generating the updated first output comprises executing the updated first software code;
the first notebook execution environment is communicatively coupled to the first language model;
the second notebook execution environment is communicatively coupled to the third language model;
the first software code and the second software code each comprises executable code selected from the list consisting of: python, VS code, and SQL;
the first output and the updated first output each comprises an output type selected from the list consisting of: output text, an image, audio data, and a software widget;
saving the notebook file as an ipynb file;
the notebook file comprises a JSON file;
the notebook file comprises an ipynb file;
distributing the notebook file;
receiving the notebook file;
the first language model, the second language model, and/or the third language model comprises an LLM;
the first language model, the second language model, and/or the third language model comprises an MM;
the first language model, the second language model, and/or the third language model each comprises a model selected from the list consisting of: a GPT, Copilot, Gemini, Claude, and Llama;
the first notebook execution environment is communicatively coupled to the second language model;
generating the third output further comprises generating, in the first notebook execution environment, a third code cell using the second prompt in the second prompt cell;
the third code cell comprises third software code;
generating the third output further comprises executing the third software code;
the third software code comprises executable code selected from the list consisting of: python, VS code, and SQL;
the second output comprises an output type selected from the list consisting of: output text, an image, audio data, and a software widget;
the output text comprises an NL passage, a data table, or html;
the markdown comprises descriptive text;
saving an updated notebook file as a JSON file comprising an updated notebook and updated metadata for the updated notebook;
the second notebook execution environment is functionally equivalent to the first notebook execution environment;
the second notebook execution environment is the first notebook execution environment;
the first language model is associated with superior code generation performance;
the second language model is associated with superior image generation and image classification performance;
the first prompt cell is associated with generation of the first code cell and the second code cell in the metadata for the notebook;
the first prompt cell is associated with generation of the first code cell and the second code cell in the metadata for the first prompt cell;
the first prompt cell is associated with generation of the first code cell in the metadata for the first code cell;
the first prompt cell is associated with generation of the second code cell in the metadata for the second code cell;
the first output comprises the second prompt cell; and
passing the first output to the first language model to assess whether the first output is correct.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 7 is a block diagram of an example computing device 700 (e.g., a computer storage device) for implementing aspects disclosed herein, and is designated generally as computing device 700. In some examples, one or more computing devices 700 are provided for an on-premises computing solution. In some examples, one or more computing devices 700 are provided as a cloud computing solution. In some examples, a combination of on-premises and cloud computing solutions are used. Computing device 700 is but one example of a suitable computing environment and is not intended to suggest any limitation as to the scope of use or functionality of the examples disclosed herein, whether used singly or as part of a larger set.

Neither should computing device 700 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 700 includes a bus 710 that directly or indirectly couples the following devices: computer storage memory 712, one or more processors 714, one or more presentation components 716, input/output (I/O) ports 718, I/O components 720, a power supply 722, and a network component 724. While computing device 700 is depicted as a seemingly single device, multiple computing devices 700 may work together and share the depicted device resources. For example, memory 712 may be distributed across multiple devices, and processor(s) 714 may be housed with different devices.

Bus 710 represents what may be one or more buses (such as an address bus, data bus, or a combination thereof). Although the various blocks of FIG. 7 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 7 and the references herein to a “computing device.” Memory 712 may take the form of the computer storage media referenced below and operatively provide storage of computer-readable instructions, data structures, program modules and other data for the computing device 700. In some examples, memory 712 stores one or more of an operating system, a universal application platform, or other program modules and program data. Memory 712 is thus able to store and access data 712a and instructions 712b that are executable by processor 714 and configured to carry out the various operations disclosed herein. Thus, computing device 700 comprises a computer storage device having computer-executable instructions 712b stored thereon.

In some examples, memory 712 includes computer storage media. Memory 712 may include any quantity of memory associated with or accessible by the computing device 700. Memory 712 may be internal to the computing device 700 (as shown in FIG. 7), external to the computing device 700 (not shown), or both (not shown). Additionally, or alternatively, the memory 712 may be distributed across multiple computing devices 700, for example, in a virtualized environment in which instruction processing is carried out on multiple computing devices 700. For the purposes of this disclosure, “computer storage media,” “computer storage memory,” “memory,” and “memory devices” are synonymous terms for the memory 712, and none of these terms include carrier waves or propagating signaling.

Processor(s) 714 may include any quantity of processing units that read data from various entities, such as memory 712 or I/O components 720. Specifically, processor(s) 714 are programmed to execute computer-executable instructions for implementing aspects of the disclosure. The instructions may be performed by the processor, by multiple processors within the computing device 700, or by a processor external to the client computing device 700. In some examples, the processor(s) 714 are programmed to execute instructions such as those illustrated in the flow charts discussed below and depicted in the accompanying drawings. Moreover, in some examples, the processor(s) 714 represents an implementation of analog techniques to perform the operations described herein. For example, the operations may be performed by an analog client computing device 700 and/or a digital client computing device 700. Presentation component(s) 716 present data indications to a user or other device. Exemplary presentation components include a display device, speaker, printing component, vibrating component, etc. One skilled in the art will understand and appreciate that computer

data may be presented in a number of ways, such as visually in a graphical user interface (GUI), audibly through speakers, wirelessly between computing devices 700, across a wired connection, or in other ways. I/O ports 718 allow computing device 700 to be logically coupled to other devices including I/O components 720, some of which may be built in. Example I/O components 720 include, for example but without limitation, a microphone, joystick, game pad, satellite dish, scanner, printer, wireless device, etc.

Computing device 700 may operate in a networked environment via the network component 724 using logical connections to one or more remote computers. In some examples, the network component 724 includes a network interface card and/or computer-executable instructions (e.g., a driver) for operating the network interface card. Communication between the computing device 700 and other devices may occur using any protocol or mechanism over any wired or wireless connection. In some examples, network component 724 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 724 communicates over wireless communication link 726 and/or a wired communication link 726a to a remote resource 728 (e.g., a cloud resource) across a computer network 730. Various different examples of communication links 726 and 726a include a wireless connection, a wired connection, and/or a dedicated link, and in some examples, at least a portion is routed through the internet.

Although described in connection with an example computing device 700, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
generate a notebook in a first notebook execution environment, wherein the notebook comprises markdown and a first prompt cell comprising a first prompt;
generate, in the first notebook execution environment, a first code cell using the first prompt in the first prompt cell, wherein generating the first code cell comprises passing the first prompt to a first language model, and wherein the first code cell comprises first software code;
generate, in the first notebook execution environment, a first output using the first software code in the first code cell, wherein generating the first output comprises executing the first software code; and
save a notebook file as a file comprising the notebook and metadata for the notebook, wherein the notebook file is further editable within a second notebook execution environment different than the first notebook execution environment.

2. The system of claim 1, wherein the instructions are further operative to:
generate, in the first notebook execution environment, a second code cell using the first prompt in the first prompt cell, wherein generating the second code cell comprises passing the first prompt to the first language model, and wherein the second code cell comprises second software code; and
generate, in the first notebook execution environment, a second output using the second software code in the second code cell, wherein generating the second output comprises executing the second software code.

3. The system of claim 2, wherein the instructions are further operative to:
identify, in the notebook file, that the first prompt cell is associated with generation of the first code cell and the second code cell using a tag or label within metadata.

4. The system of claim 1, wherein the notebook further comprises a second prompt cell comprising a second prompt, and wherein the instructions are further operative to:
generate, in the first notebook execution environment, a third output using the second prompt in the second prompt cell, wherein generating the third output comprises passing the second prompt to a second language model different than the first language model.

5. The system of claim 4, wherein the first language model and the second language model differ in speed and/or accuracy for each code generation, image generation, and image classification.

6. The system of claim 4, wherein generating the third output further comprises:
in addition to passing the second prompt to the second language model, also passing another prompt or markdown to the second language model.

7. The system of claim 1, wherein the instructions are further operative to:
open the notebook file in the second notebook execution environment, wherein the notebook file comprises the notebook and the metadata for the notebook, and wherein the notebook comprises the markdown, the first prompt cell, the first code cell, and the first output;
edit the first prompt in the first prompt cell;
generate, in the second notebook execution environment, an updated first code cell using the edited first prompt, wherein the updated first code cell comprises updated first software code; and
generate, in the second notebook execution environment, an updated first output using the updated first software code in the updated first code cell, wherein generating the updated first output comprises executing the updated first software code.

8. A computer-implemented method comprising:
generating a notebook in a first notebook execution environment, wherein the notebook comprises markdown and a first prompt cell comprising a first prompt;
generating, in the first notebook execution environment, a first code cell using the first prompt in the first prompt cell, wherein generating the first code cell comprises passing the first prompt to a first language model, and wherein the first code cell comprises first software code;
generating, in the first notebook execution environment, a first output using the first software code in the first code cell, wherein generating the first output comprises executing the first software code; and
saving a notebook file as a file comprising the notebook and metadata for the notebook, wherein the notebook file is further editable within a second notebook execution environment different than the first notebook execution environment.

9. The method of claim 8, further comprising:
generating, in the first notebook execution environment, a second code cell using the first prompt in the first prompt cell, wherein generating the second code cell comprises passing the first prompt to the first language model, and wherein the second code cell comprises second software code; and
generating, in the first notebook execution environment, a second output using the second software code in the second code cell, wherein generating the second output comprises executing the second software code.

10. The method of claim 9, further comprising:
identifying, in the notebook file, that the first prompt cell is associated with generation of the first code cell and the second code cell using a tag or label within metadata.

11. The method of claim 8, wherein the notebook further comprises a second prompt cell comprising a second prompt, and wherein the method further comprises:
generating, in the first notebook execution environment, a third output using the second prompt in the second prompt cell, wherein generating the third output comprises passing the second prompt to a second language model different than the first language model.

12. The method of claim 11, wherein the first language model and the second language model differ in speed and/or accuracy for each code generation, image generation, and image classification.

13. The method of claim 11, wherein generating the third output further comprises:
in addition to passing the second prompt to the second language model, also passing another prompt or markdown to the second language model for context.

14. The method of claim 8, further comprising:
opening the notebook file in the second notebook execution environment, wherein the notebook file comprises the notebook and the metadata for the notebook, and wherein the notebook comprises the markdown, the first prompt cell, the first code cell, and the first output;
editing the first prompt in the first prompt cell;
generating, in the second notebook execution environment, an updated first code cell using the edited first prompt, wherein the updated first code cell comprises updated first software code; and
generating, in the second notebook execution environment, an updated first output using the updated first software code in the updated first code cell, wherein generating the updated first output comprises executing the updated first software code.

15. The method of claim 14,
wherein the first notebook execution environment is communicatively coupled to the first language model;
wherein the first software code comprises executable code selected from the list consisting of:
python, visual studio (VS) code, and structured query language (SQL); and
wherein the first output and the updated first output each comprises an output type selected from the list consisting of:
output text, an image, audio data, and a software widget.

16. A computer storage device having computer-executable instructions stored thereon, which, on execution by a computer, cause the computer to perform operations comprising:
generating a notebook in a first notebook execution environment, wherein the notebook comprises markdown and a first prompt cell comprising a first prompt;
generating, in the first notebook execution environment, a first code cell using the first prompt in the first prompt cell, wherein generating the first code cell comprises passing the first prompt to a first language model, and wherein the first code cell comprises first software code;
generating, in the first notebook execution environment, a first output using the first software code in the first code cell, wherein generating the first output comprises executing the first software code; and
saving a notebook file as a file comprising the notebook and metadata for the notebook, wherein the notebook file is further editable within a second notebook execution environment different than the first notebook execution environment.

17. The computer storage device of claim 16, wherein the operations further comprise:
generating, in the first notebook execution environment, a second code cell using the first prompt in the first prompt cell, wherein generating the second code cell comprises passing the first prompt to the first language model, and wherein the second code cell comprises second software code; and
generating, in the first notebook execution environment, a second output using the second software code in the second code cell, wherein generating the second output comprises executing the second software code.

18. The computer storage device of claim 17, wherein the operations further comprise:
identifying, in the notebook file, that the first prompt cell is associated with generation of the first code cell and the second code cell using a tag or label within metadata.

19. The computer storage device of claim 16, wherein the notebook further comprises a second prompt cell comprising a second prompt, and wherein the operations further comprise:
generating, in the first notebook execution environment, a third output using the second prompt in the second prompt cell, wherein generating the third output comprises passing the second prompt to a second language model different than the first language model.

20. The computer storage device of claim 16, wherein the operations further comprise:
opening the notebook file in the second notebook execution environment, wherein the notebook file comprises the notebook and the metadata for the notebook, and wherein the notebook comprises the markdown, the first prompt cell, the first code cell, and the first output;
editing the first prompt in the first prompt cell;
generating, in the second notebook execution environment, an updated first code cell using the edited first prompt, wherein the updated first code cell comprises updated first software code; and
generating, in the second notebook execution environment, an updated first output using the updated first software code in the updated first code cell, wherein generating the updated first output comprises executing the updated first software code.
